(19) United States
(12) Patent Application Publication
(10) Pub. No.: US 2002/0150290 A1
(43) Pub. Date: Oct. 17, 2002

(54) Method and apparatus for color comparison in a digital camera

(76) Inventors: Mark N. Robins, Greeley, CO (US); Heather N. Bean, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/835,213

(22) Filed: Apr. 13, 2001

(51) Int. Cl. G06K 9/00

(52) U.S. Cl. 382/162

(57) ABSTRACT

A digital camera stores and compares colors. In one exemplary embodiment of the present invention, a color may be captured by and stored in the digital camera and subsequently uploaded to a computing device for use in applications. In another exemplary embodiment, a color associated with a candidate specimen is compared with a reference color stored in the digital camera, the difference between the colors is reported graphically, and a signal is given when the colors differ by less than a predetermined tolerance. Illuminant normalization is employed to ensure accurate color comparisons.

### FIELD OF THE INVENTION

The present invention relates generally to digital cameras and more specifically to a method and associated apparatus for comparing colors in a digital camera.

### BACKGROUND OF THE INVENTION

People sometimes encounter colors they like on everyday objects or in nature. For example, someone may see a parked car, house, curtain, garment, or other object containing a color that he or she finds especially attractive. The observer may desire to remember the color and match it later at, for example, a paint or fabric store. Since taking a sample of the color from the object is often not feasible, one solution is to take a picture of the object of interest. However, taking a picture using a traditional silver-emulsion-film camera is an imprecise method to match colors due to such factors as lens filters, exposure errors, and film processing variability and imperfections. Differences in illuminant and illumination level between the photograph and the color specimens with which it is ultimately compared further complicates the problem. For example, colors typically appear different under fluorescent lighting than under incandescent lighting. A digital camera provides greater convenience and immediate feedback than traditional photography, but the difficulties with illuminant and illumination level apply just as much to digital photography as to the conventional type.

It is thus apparent that there is a need in the art for an improved method or apparatus for remembering and comparing colors.

### SUMMARY OF THE INVENTION

A method is provided for storing a reference color in a digital camera and for comparing the color of a candidate specimen with the reference color. A digital camera is also provided for carrying out the methods.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of a digital camera in accordance with the present invention.

FIG. 2 is a flowchart of the operation of the digital camera shown in FIG. 1 in accordance with one aspect of the present invention.

FIG. 3A is an illustration of one method for specifying a color-analysis sub-image in the digital camera shown in FIG. 1.

FIG. 3B is an illustration of another method for specifying a color-analysis sub-image in the digital camera shown in FIG. 1.

FIG. 4 is a flowchart of the operation of the digital camera shown in FIG. 1 in accordance with another aspect of the invention.

FIG. 5A is an illustration of one method for reporting the difference between the color of a candidate specimen and a reference color in accordance with another embodiment of the present invention.

FIG. 5B is an illustration of a different method for reporting the difference between the color of a candidate specimen and a reference color in accordance with yet another embodiment of the present invention.

### DETAILED DESCRIPTION OF THE INVENTION

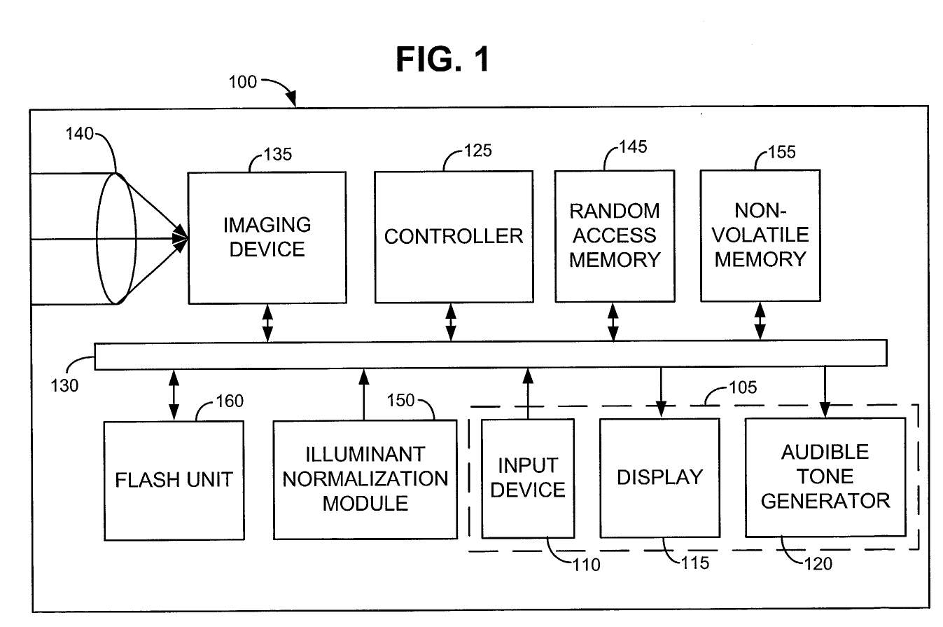

FIG. 1 is a functional block diagram of a digital camera 100 in accordance with one exemplary embodiment of the present invention. In FIG. 1, user interface 105 comprises input device 110, display 115, and optional audible tone generator 120. Input device 110 sends commands to controller 125 over data bus 130 to specify the modes of operation of digital camera 100. User interface 105 provides feedback to users via display 115 and optional audible tone generator 120. Imaging device 135 converts an optical image of a subject received from optical system 140 to a digital image. The digital image may be stored temporarily in optional random access memory (RAM) 145. Illuminant normalization module 150 compensates for different illuminants from one scene to another to make accurate color comparison possible. Non-volatile memory 155 provides long-term storage of color descriptions and digital images. Optional flash unit 160 may be used to illuminate subjects with a known illuminant and to compensate for low-light conditions.

One example of how the illuminant of a digital image may be estimated and corrected may be found in U.S. Pat. No. 6,038,339, “White Point Determination Using Correlation Matrix Memory,” assigned to Hewlett-Packard Company, the disclosure of which is herein incorporated by reference. In U.S. Pat. No. 6,038,339, a correlation matrix memory is built to correlate the data from any digital image with reference images under a range of illuminants. The digital image data from digital camera 100 is converted to chromaticity coordinates, and a vector is created corresponding to the values existing in the scene. This vector is multiplied by each column in the correlation matrix, yielding a new matrix. Each column is then summed, and the resulting values form a vector, the components of which represent the likelihood of each reference source being the illuminant of the scene. The vector values can be subsequently density plotted, where each value is plotted at the chromaticity of the illumination for that particular column. From this plot, normal statistical methods may be used to estimate the likely illuminant of the scene. Once the likely illuminant has been estimated, the spectral characteristics of the illuminant may be compensated to normalize the illuminant of the digital image to approximate a standard illuminant, to be discussed in more detail in a later portion of this detailed description.

A variety of different color representations may be used with the present invention. One method for describing colors that is well known in the art is the use of red, blue, and green (RGB) color components or coordinates, sometimes referred to as tristimulus values. In the RGB representation of a digital image, each pixel is represented by RGB components, each of which is represented by, typically, 8-12 bits in digital camera applications. As those skilled in the art will recognize, the RGB color space is not desirable for colorimetric calculations such as color differences because it is non-linear with respect to human visual perception. To compare colors accurately, a uniform color space is desirable in which equal distances in any direction in the three-dimensional space correspond to color differences of approximately equal perceptual magnitude. One well-known color space that is approximately uniform for small changes in color is the standard Commission Internationale de l'Éclairage (CIE) L* u* v* color space comprising a luminance and two chrominance coordinates, respectively. However, other approximately uniform color spaces are possible such as L* a* b*, which is popular in the textiles industry. The application of the present invention is not limited to any particular color representation. Also, throughout this detailed description, “saving” or “storing” a color will denote storing in non-volatile memory 155 a specification of the color (i.e., color coordinates), a digital image from which the color was determined, or both.

In a typical implementation, imaging device 135 comprises a charge-coupled device (CCD), an analog-to-digital converter (A/D), a gain control, and a digital signal processor (DSP), as is well known in the art (not shown in FIG. 1). Input device 110 typically comprises one or more buttons for selecting modes and options in digital camera 100. Audible tone generator 120 is an optional component of digital camera 100 and has been included in FIG. 1 for the purpose of illustration only. In some implementations, a flashing or persistent light, a vibrator, or other method of providing feedback to users may be preferable to an audible tone. Illuminant normalization module 150 may be implemented in hardware, software, firmware, or a combination thereof. Non-volatile memory 155 is typically flash memory but may, in some implementations, be of the removable type, such as a memory stick or magnetic disk.

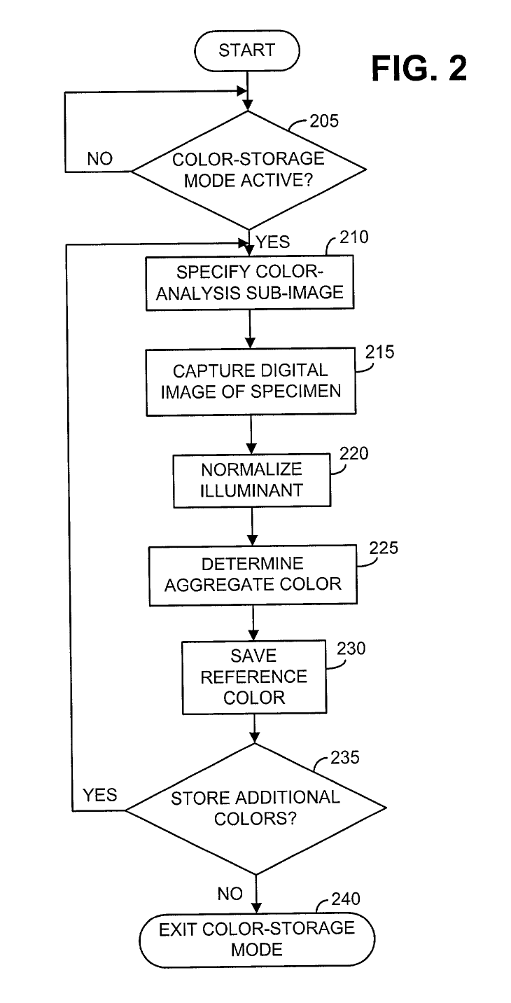

FIG. 2 is a flowchart of the operation of digital camera 100 in accordance with one aspect of the present invention, a method for storing a reference color in a digital camera. At 205, controller 125 determines whether or not color-storage mode has been activated in digital camera 100. If so, control proceeds to 210. In attempting to isolate a particular color contained in scene, it is sometimes helpful to restrict color analysis to a relatively small sub-region of the scene. Thus, at 210 an optional color-analysis sub-image may be specified on display 115 using input device 110. More detail regarding the specification of a color-analysis sub-image will be provided later in this detailed description. Once a specimen containing a color of interest has been identified, a digital image of the specimen is captured at 215. The digital image may be stored temporarily in RAM 145. The use of optional flash unit 160 in capturing the digital image at 215 provides a known illuminant, making subsequent color comparison easier and more precise. If no flash is used, illuminant shortcomings may be ignored, and the present invention may still be used to store and compare colors. An alternative, if no flash is used, is to estimate and normalize the illuminant of the digital image, shown at 220 in connection with this particular embodiment of the invention. Illuminant normalization module 150 estimates the illuminant present in the digital image and produces a normalized version of the digital image based on a standard illuminant. For example, the illuminant may be corrected to one of several CIE standard illuminants such as Illuminant A (gas-filled tungsten lamp at 2848°K) or Illuminant C (average daylight), which are well known in the art. The normalized digital image produced at 220 may also be stored temporarily in RAM 145. Even though the specimen may appear to contain only one color, not every pixel in the digital image will necessarily have identical color components (e.g., RGB or L* u* v*). Therefore, the normalized digital image is analyzed at 225 to determine an aggregate color within the optional color-analysis sub-image specified at 210. Many possible statistical measures may be used in determining an aggregate color. Examples include the mean, the median, or the mode of the color components within the color-analysis sub-image. Once an aggregate color has been determined at 225, it is saved as a reference color in non-volatile memory 155 at 230. If additional reference colors are to be stored at 235, control returns to 210. Otherwise color-storage mode is exited at 240. Optionally, a user may name each stored reference color using input device 100, or digital camera 100 may automatically generate unique names for the stored reference colors such as “Color 1,” “Color 2,” and so forth. Using input device 110, a list of stored reference colors may be recalled, and a specific stored reference color may be selected from the list as the active reference color for subsequent comparison and matching. Color comparison will be explained in a later portion of this detailed description.

Instead of obtaining the reference color as described in connection with FIG. 2, the reference color may instead be obtained in the form of color coordinates from an external source, without the need to capture a digital image of a specimen. For example, color coordinates specifying a particular color may be input directly via input device 110, or color coordinates may be downloaded to digital camera 110 from a different external source such as a personal computer, which may in turn be connected to the Internet. In this implementation, it is possible to obtain color descriptions from the Internet, download them to digital camera 100, and search for matching colors in candidate specimens. Communication interfaces between digital cameras and, for example, desktop or laptop computers capable of supporting this implementation are well known in the art.

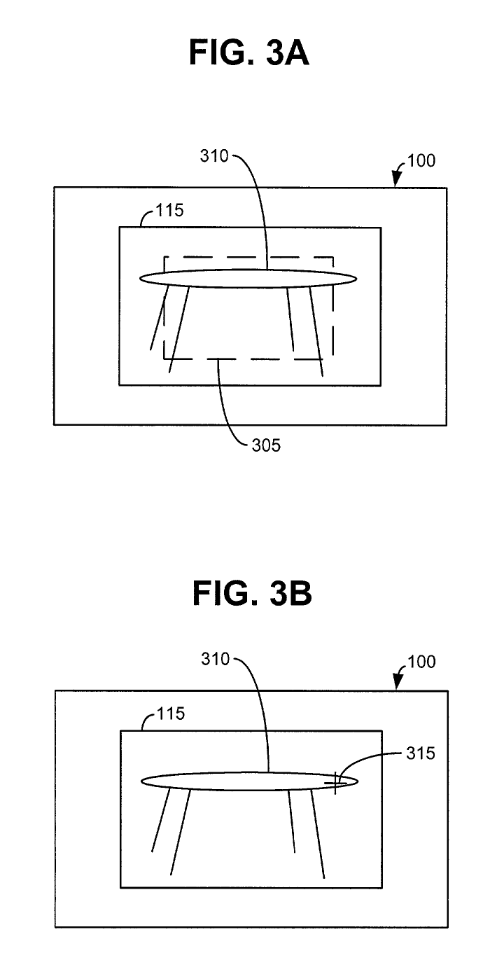

The optional color-analysis sub-image that may be specified at 210 is that portion of the normalized digital image that is analyzed in determining the aggregate color, which ultimately becomes the saved reference color. All pixels outside the color-analysis sub-image are ignored for the purpose of determining the aggregate color. FIG. 3A illustrates one approach to specifying a color-analysis sub-image. Display 115 on digital camera 100 includes bounding box 305, the interior of which comprises the color-analysis sub-image. Bounding box 305 may appear automatically on display 115 whenever color-comparison mode is activated. Only that portion of specimen 310 lying within bounding box 305 is included in the determination of the aggregate color at 225. Controller 125 interacts with input device 110 and display 115 containing bounding box 305 to determine which portion of the normalized digital image to extract for determining the aggregate color. However, those skilled in the art will recognize that greater accuracy in the estimation of the illuminant at 220, when it is necessary, may be obtained by including all pixels in the normalized digital image, not only those within the color-analysis sub-image.

In a different embodiment of the color-storage aspect of the present invention, bounding box 305 is replaced by a more precise fiducial such as a moveable crosshair. In this embodiment, the color-analysis sub-image is restricted to just a few pixels lying beneath the crosshair, providing for very precise pinpointing of a specific color within a scene. Further, since the color-analysis sub-image comprises only a few pixels, the computational burden on controller 125 in determining the aggregate color is reduced. FIG. 3B illustrates one possible implementation of this embodiment. Crosshair 315 replaces bounding box 305 in defining the portion of specimen 310 comprising the color-analysis sub-image.

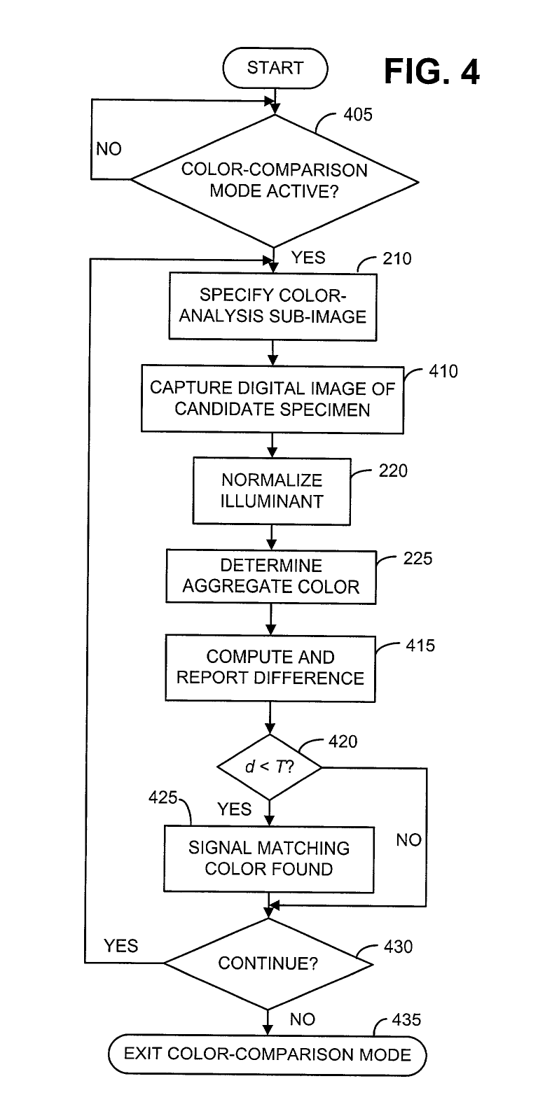

FIG. 4 is a flowchart of the operation of digital camera 100 in accordance with another aspect of the invention, that dealing with color comparison. Controller 125 determines at 405 whether a color-comparison mode has been activated in digital camera 100. If so, an optional color-analysis sub-image is specified at 210 as explained in connection with FIG. 2. Once a candidate specimen has been identified for comparison with the currently selected reference color, a digital image of the candidate specimen is captured at 410. Image capture at 410 may be automatic or manually initiated by the user. As explained in connection with FIG. 2, flash is one effective method for providing a known illuminant in the image captured at 410. It is desirable, though not essential, that flash be used in producing the digital images from which colors to be compared are derived. However, the present invention may be used with or without flash. At 220, the illuminant of the digital image is optionally normalized, and an aggregate color is determined at 225, as explained in connection with FIG. 2. Controller 125 computes the difference between the aggregate color and the currently selected reference color at 415. Optionally, the difference is also reported at 415. More will be said about reporting the difference between the two colors later in this detailed description. Although many different colorimetric methods exist for comparing colors, one suitable definition of the difference between two colors is the following:

d=\sqrt{(L*₂−L*₁)²+(u*₂−u*₁)²+(v*₂−v*₁)²}, Equation 1

where (L*₁,u*₁,v*₁) are the L*, u*, v* components of the stored reference color, (L*₂,u*₂,v*₂) are the L*, u*, v* components of the aggregate color associated with the candidate specimen, and d is the difference between the two colors. Those skilled in the art will recognize Equation 1 as the CIE 1976 (L* u* v*) color difference or CIEL UV. The difference d is compared with a predetermined tolerance T at 420. The tolerance T may be fixed, or it may be adjusted to fit different applications. The tolerance T may be specified in absolute terms for direct comparison with d, as per cent error between the reference color and the aggregate color of the candidate specimen, or as a multiple of a standard minimum perceptible color difference (MPCD). The MPCD is a well-known concept in color science corresponding to the “just perceptible color difference” between two colors as they are compared under standard conditions. Those skilled in the art will recognize that per cent error can easily be converted to a tolerance T in units compatible with d in Equation 1. In a typical implementation, the user may select from among a set of possible choices such as “close,” “very close,” or “best possible” match, each of which may correspond to a specific per cent error or multiple of the MPCD. For example, a “best possible” match may correspond to one MPCD, and a “close” match may correspond to five MPCDs. If d is less than T at 420, a match is signaled at 425. Signaling the match may comprise visual feedback on display 115, one aspect of which will be explained more fully in a later portion of this description, audible feedback such as a beep or tone, or other forms of feedback such as vibration, a flashing light, a persistent light, or a text message on display 115 such as “match found.” At 430, additional candidate specimens may be compared with the reference color by return to 210, or color-comparison mode may be exited at 435.

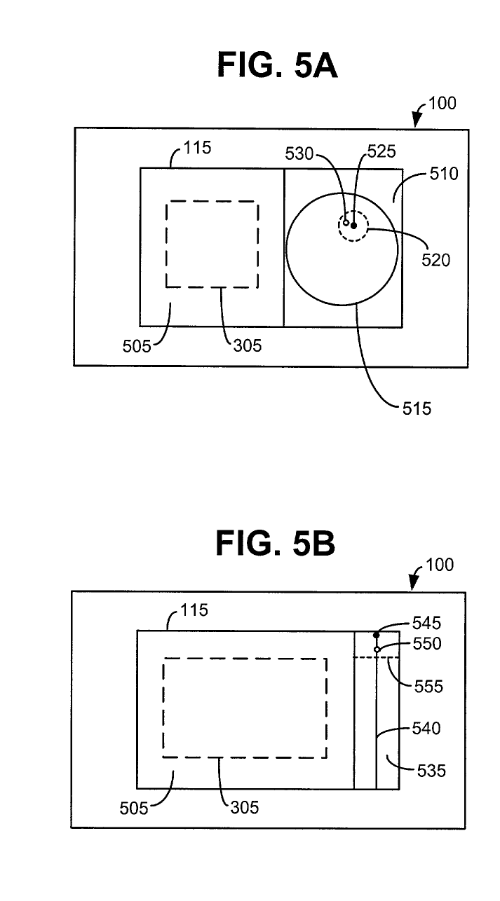

A variety of techniques may be used to report the difference d at 415. One straightforward approach is simply to display a number on display 115 indicating the closeness of the match. The number may be d, multiples of the MPCD, per cent error, or some other appropriate figure of merit. Alternatively, a text string such as “not close,” “close,” or “very close,” may be shown on display 115. Another effective approach is shown in FIG. 5A, where display 115 is divided into two regions, 505 and 510. Region 505 is a smaller version of the normal display, which displays the current scene received from optical system 140 or, in some situations, a captured digital image. Bounding box 305 defines the color-analysis sub-image associated with the current color difference indication provided in region 510. Alternatively, a crosshair may be used to define a more precise color-analysis sub-image as explained in connection with FIG. 3B. Region 510 contains a color wheel 515 such as those well known in the art and commonly used in computer image editing and graphics applications. Tolerance T is indicated on color wheel 515 as a circular boundary concentric with stored reference color 525. Aggregate color 530 is also shown in its applicable position on color wheel 515. In the particular example illustrated in FIG. 5A, a match has been found. That is, the aggregate color is within T of the reference color. One alternative to a color wheel is a color map, which is typically square or rectangular in shape. A color map is essentially a two-dimensional matrix containing rows and columns of color samples. In this case, tolerance T may be displayed as a square boundary concentric with the reference color on the color map.

Alternatively, a linear approach may be used to provide a larger region 505 for displaying scenes, as shown in FIG. 5B. In FIG. 5B, region 535 contains a linear gauge to report the difference d. Line 540 represents a continuum of colors, from those unlike the stored reference color at one end to the precise stored reference color itself at the opposite end. The bottom end of line 540 represents the set of all colors that differ from the stored reference color by greater than a predetermined amount. For example, the bottom end of line 540, in one implementation, may represent all colors that differ from the stored reference color by more than 50 MPCDs. The opposite end of line 540 represents the stored reference color, which is indicated as dot 545 in FIG. 5B. Open circle 550 represents the aggregate color associated with the candidate specimen, and tolerance T is represented as perpendicular line 555. Thus, line 540 may be thought of as comprising two portions divided by perpendicular line 555. The portion of line 540 above perpendicular line 555 represents the set of all colors that differ from the reference color by less than T, and the remainder of the line represents the set of all colors that differ from the reference color by an amount greater than or equal to T. Those skilled in the art will recognize that there are many alternative ways in which to arrange a linear gauge such as that shown in region 535 of FIG. 5B. Variations include, but are not limited to, horizontal rather than vertical orientation, different markings to indicate the colors being compared, and a different mark to indicate tolerance T. Those skilled in the art will also recognize that, if the difference between the aggregate color associated with a candidate specimen and the stored reference color exceeds the range of the linear gauge, line 540 may be rescaled to include whatever difference is computed at 415. Conversely, as the aggregate color associated with each of a series of candidate specimens more closely approaches the reference color, line 540 may be rescaled to encompass a smaller range of color differences (e.g., 20 MPCDs), thereby improving the resolution of the reported difference.

Another embodiment of the color comparison aspect of the present invention provides for multiple color matches within a single color-analysis sub-image. In this embodiment, the color-analysis sub-image may be larger than in the embodiment discussed previously, possibly comprising the entire normalized digital image. Controller 125 analyzes the color-analysis sub-image associated with the candidate specimen to identify regions of similar color. For each such region, controller 125 determines an aggregate color. Those regions of the normalized digital image for which the associated aggregate color differs from the stored reference color by less than tolerance T are shown at normal intensity on display 115. Those regions for which the associated aggregate color differs by T or more are shown at reduced intensity on display 115. For example, the regions for which no color match occurs may be shown at half intensity.

In some situations, comparing colors is complicated by overexposure (illumination level too high) or underexposure (illumination level too low). Illumination level compensation may be added as an additional optional feature in any embodiment of the present invention. One implementation is for controller 125 to convert RGB components to chromaticity coordinates and to compare only the chrominance portion. In most cases, however, unless a digital image is grossly under or overexposed, illuminant normalization is sufficient to accomplish the purposes of the present invention.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for comparing a color of a candidate specimen with a reference color stored in a digital camera, the method comprising:
capturing a digital image of the candidate specimen;
determining a color in the digital image of the candidate specimen; and
computing the difference between the color of the candidate specimen and the reference color.

2. The method of claim 1, further comprising:
illuminating the candidate specimen using flash for capturing the digital image of the candidate specimen.

3. The method of claim 1, further comprising:
normalizing the illuminant of the digital image to produce a normalized digital image, wherein the color of the candidate specimen is determined from the normalized digital image.

4. The method of claim 1, further comprising:
specifying a color-analysis sub-image after activating a color-comparison mode in the digital camera and prior to capturing a digital image of the candidate specimen.

5. The method of claim 1, further comprising:
reporting the difference.

6. The method of claim 5, wherein reporting the difference comprises representing the color of the candidate specimen and the reference color on a color wheel.

7. The method of claim 5, wherein reporting the difference comprises representing the color of the candidate specimen and the reference color on a color map.

8. The method of claim 5, wherein reporting the difference comprises representing the color of the candidate specimen on a line having first and second ends, the first end representing the reference color and the second end representing the set of all colors that differ from the reference color by greater than a predetermined amount.

9. The method of claim 1, further comprising:
indicating when the difference is less than a predetermined tolerance.

10. The method of claim 9, wherein indicating when the difference is less than a predetermined tolerance comprises representing on a color wheel the color of the candidate specimen, the reference color, and a circular boundary concentric with the reference color, the circular boundary encircling the color of the candidate specimen and the circular boundary representing the predetermined tolerance.

11. The method of claim 9, wherein indicating when the difference is less than a predetermined tolerance comprises representing the color of the candidate specimen on a line having first and second portions, the first portion representing the set of all colors that differ from the reference color by less than the predetermined tolerance and the second portion representing the set of all colors that differ from the reference color by an amount equal to or greater than the predetermined tolerance.

12. The method of claim 9, wherein indicating when the difference is less than a predetermined tolerance comprises emitting an audible signal.

13. The method of claim 1, wherein, prior to capturing a digital image of the candidate specimen, the method further comprises:
capturing a digital image of a specimen prior to capturing a digital image of the candidate specimen;
determining a reference color in the digital image of the specimen; and
saving the reference color.

14. The method of claim 13, further comprising:
normalizing the illuminant of the digital image of the specimen to produce a normalized digital image of the specimen, wherein the reference color is determined from the normalized digital image of the specimen; and
normalizing the illuminant of the digital image of the candidate specimen to produce a normalized digital image of the candidate specimen, wherein the color of the candidate specimen is determined from the normalized digital image of the candidate specimen.

15. The method of claim 13, further comprising:
illuminating the specimen using flash for capturing a digital image of the specimen; and
illuminating the candidate specimen using flash for capturing a digital image of the candidate specimen.

16. The method of claim 1, wherein the digital camera receives the reference color as a set of color coordinates from an external source.

17. A method for comparing a color of a candidate specimen with a reference color stored in a digital camera, the method comprising:
capturing a digital image of the candidate specimen;
dividing the digital image into a plurality of sub-regions;
determining a color for each of the sub-regions; and
computing the difference between the color of each region and the reference color.

18. The method of claim 17, further comprising:
displaying in normal intensity each sub-region for which the corresponding difference is less than a predetermined tolerance and displaying all other sub-regions in reduced intensity.

19. A method for storing a reference color in a digital camera, the method comprising:
capturing a digital image of a specimen;
determining a reference color in the digital image of the specimen; and
saving the reference color.

20. The method of claim 19, further comprising:
illuminating the specimen using flash prior to capturing a digital image of the specimen.

21. The method of claim 19, further comprising:
normalizing the illuminant of the digital image to produce a normalized digital image of the specimen after capturing a digital image of the specimen and prior to determining a reference color in the digital image of the specimen, wherein the reference color is determined from the normalized digital image of the specimen.

22. The method of claim 19, further comprising:
specifying a color-analysis sub-image prior to capturing a digital image of the specimen.

23. A digital camera, comprising:
an optical system for producing optical images of subjects;
an imaging device for converting optical images received from the optical system to corresponding digital images;
a memory for storing the digital images; and
a controller configured to compute the difference between a first color associated with a first digital image and a second color associated with a second digital image.

24. The digital camera of claim 23, further comprising:
a flash unit for illuminating the subjects.

25. The digital camera of claim 23, further comprising:
an illuminant normalization module for normalizing the illuminant of the digital images.

26. The digital camera of claim 23, wherein the controller is adapted to extract a color-analysis sub-image from each of the digital images.

27. The digital camera of claim 26, further comprising:
a display for specifying the color-analysis sub-image.

28. The digital camera of claim 23, further comprising:
a display for reporting the difference.

29. The digital camera of claim 23, further comprising:
a device for indicating when the difference is less than a predetermined tolerance.

30. A digital camera, comprising:
means for collecting optical images of subjects;
means for converting the optical images to corresponding digital images;
means for storing the digital images; and
means for computing the difference between a first color associated with a first digital image and a second color associated with a second digital image.

31. The digital camera of claim 30, further comprising:
means for illuminating the subjects.

32. The digital camera of claim 30, further comprising:
means for normalizing the illuminant of the digital images.

33. The digital camera of claim 30, further comprising:
means for specifying a color-analysis sub-image for each of the digital images.

34. The digital camera of claim 30, further comprising:
means for reporting the difference.

35. The digital camera of claim 30, further comprising:
means for indicating when the difference is less than a predetermined tolerance.
